(19) United States
(12) Patent Application Publication
(10) Pub. No.: US 2011/0022633 A1
(43) Pub. Date: Jan. 27, 2011

(54) DISTRIBUTED MEDIA FINGERPRINT REPOSITORIES

(75) Inventors: Philip John Bernosky, Saratoga, CA (US); Claus Bauer, Beijing (CN); Wenyu Jiang, Beijing (CN)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/935,080

(22) PCT Filed: Mar. 31, 2009
(86) PCT No.: PCT/US09/38876

§ 371 Date: Sep. 28, 2010

Related U.S. Application Data
(60) Provisional application No. 61/040,865, filed on Mar. 31, 2008.

(51) Int. Cl. G06F 17/30

(52) U.S. Cl. 707/770; 707/E17.014; 707/E17.032

(57) ABSTRACT

Media fingerprints, which are each derived from and uniquely correspond to a portion of media content, are stored over a distributed database. An instance of one or more information containers of the distributed database are each disposed over two or more computing devices, which are communicatively linked over a data network. The media fingerprints are distributed among the information containers based on a criterion that relates individually to each of the media fingerprints. Upon a query directed to one of the media fingerprints, at least one of the two or more computing devices is selected based on the criterion. The query is executed over the distributed database instance of the selected computing device.

### PRIORITY CLAIM AND RELATED APPLICATIONS

This Application claims priority to and benefit of co-pending Provisional U.S. patent application No. 61/040,865, filed on Mar. 31, 2008, by Philip Bernosky, Claus Bauer and Wenyu Jiang, entitled “Distributed Media Fingerprint Repositories,” (with Patent Docket No. D07051US01), the contents which are hereby incorporated by reference in its entirety.

### TECHNOLOGY

The present invention relates generally to media. More specifically, embodiments of the present invention relate to distributed media fingerprint repositories.

### BACKGROUND

Audio and video media comprise an essentially ubiquitous feature of modern activity. Multimedia content, such as most modern movies, includes more than one kind of medium, such as both its video content and an audio soundtrack. Modern enterprises of virtually every kind and individuals from many walks of life use audio and video media content in a wide variety of both unique and related ways. Entertainment, commerce and advertising, education, instruction and training, computing and networking, broadcast, enterprise and telecommunications, are but a small sample of modern endeavors in which audio and video media content find common use.

Audio media include music, speech and sounds recorded on individual compact disks (CD) or other storage formats, streamed as digital files between server and client computers over networks, or transmitted with analog and digital electromagnetic signals. Examples of video media include movies and other recorded performances, presentations and animations, and portions thereof, sometimes called clips. It has become about as familiar to find users watching movies from Digital Versatile Disks (DVD) playing on laptop computers while commuting as at home on entertainment systems or in theaters. Concerts from popular bands are streamed over the internet and enjoyed by users as audio and/or viewed as well in webcasts of the performance. Extremely portable lightweight, small form factor, low cost players of digital audio files have gained widespread popularity. Cellular phones, now essentially ubiquitous, and personal digital assistants (PDA) and handheld computers all have versatile functionality. Not just telecommunication devices, modern cell phones access the Internet and stream audio and video content therefrom and, it is no longer unusual to find game enthusiasts participating in networked video game play and fans watching sporting events therewith.

As a result of its widespread and growing use, vast quantities of audio and media content exist. Given the sheer quantity and variety of audio and video media content that exist, and the expanding growth of that content over time, an ability to identify content is of value. Media fingerprints comprise a technique for identifying media content.

The approaches described in this section could be pursued, but have not necessarily been previously conceived or pursued. Unless otherwise indicated, it should not be assumed that any approaches described in this section qualify as prior art merely by virtue of their inclusion herein. Similarly, issues identified with respect to one or more approaches should not assume to have been recognized in any prior art on the basis of this section, unless otherwise indicated.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example distributed database network, according to an embodiment of the present invention;

FIG. 2 depicts an example system, according to an embodiment of the present invention;

FIG. 3 depicts a flowchart for an example procedure, according to an embodiment of the present invention;

FIG. 4 depicts a flowchart for another example procedure, according to an embodiment of the present invention; and

FIG. 5 depicts an example computer system platform, with which an embodiment of the present invention may be implemented.

### DESCRIPTION OF EXAMPLE EMBODIMENTS

Example embodiments relating to distributed media fingerprint repositories are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

### Overview

Example embodiments relate to distributed media fingerprint repositories. Media fingerprints, which are each derived from and uniquely correspond to a portion of media content, are stored over a distributed database. An instance of one or more information containers of the distributed database are each disposed over two or more computing devices, which are communicatively linked over a data network. The media fingerprints are distributed among the information containers based on a criterion that relates individually to each of the media fingerprints. Upon a query directed to one of the media fingerprints, at least one of the two or more computing devices is selected based on the criterion. The query is executed over the distributed database instance of the selected computing device(s).

The criterion may relate to, for example, a quality of timeliness, a value, or statistical information, which are associated with the media fingerprint or the media content from which it is derived and to which it uniquely corresponds. The selection may also be performed based on a characteristic of computing device (e.g., computer). For example, the computer characteristic upon which the selection may also be based may include a network or physical location of the computer, a computational attribute or a networking attribute of the computer at query time, statistical information that relates to the computer, latency associated with the computer, or the availability of the computer over the data network at query time, or a condition of the data network at query time, etc.

Information container instances of the distributed database may be disposed over computing devices such as servers, which may include an edge server of the data network or a server associated with a content distribution service (CDS), etc. The data network may include one or more peer to peer (P2P) networks. Where the data network includes a P2P network, information container instances of the distributed database may be disposed over one or more clients of the P2P network.

The media content may stream over the data network. For example, an instance of the media content may stream in response to a request for access to the media content from a client of the data network. The query may thus relate to the streaming media content instance. The query is computed and a corresponding result is returned. An action may be performed that may relate to controlling the streaming of the media content instance based on the returned query result, such as deterring the streaming of the media content instance. For example, where the client requesting the media content lacks authorization for access thereto, streaming of the media content instance to that client may be blocked, prevented, interrupted, distorted, delayed, replaced, interfered with, or the like. Where streaming of the media content instance to that particular client is deterred, an embodiment allows the media content to stream over a portion of the data network apart from that client. Also for example, the action performed based on the returned query result may include providing information, which may be associated with the media content instance (such as auxiliary, advertising, educational, instructional, commercial or other information that relates in some way to the media content), e.g., in real time or at least near real time in relation to the streaming of the media content instance. The action may further include, for example, a mechanism to allow access thereto, which may have been deterred, to begin, resume, or continue with the deterrence abated or removed.

Managing the distributed database may include redistributing media fingerprints (e.g., dynamically reassigning storage locations, addresses, etc. thereof) among the information containers of the distributed database, further based on the criterion. Thus, selecting the computer a particular information container of the distributed database or executing the fingerprint related query thereon may be further based on the redistribution. For example, the timeliness of media content may reflect its value or that of the media fingerprints derived therefrom. As media content ages for instance, its value may decline in a sense. The value of storing the fingerprints derived from the media content may thus diminish in relation to costs associated therewith. Relatively high value fingerprints, e.g., associated with timely media content, may be stored over more information container instances of the distributed database with more computing devices than lower value fingerprints. As the media content becomes less timely (e.g., ages out) however, the cost of storing the corresponding fingerprints over multiple information container instances (e.g., mirroring) may rise in relation to the value of doing so. The fingerprints may thus be redistributed, e.g., over fewer of the information container instances of the distributed database. Some of the media fingerprints may be deleted from storage.

Embodiments may relate to one or more computer executable processes (e.g., procedures, methods, algorithms or the like). Embodiments may also relate to computer systems, which may include means for performing such processes. Embodiments may further relate to computer readable storage media, which may include computer executable instructions that may cause a processor which may, upon executing the instructions, control a computer to perform such processes and/or configure (e.g., program) such a computer system.

### EXAMPLE EMBODIMENTS

### Example Distributed Media Fingerprint Database

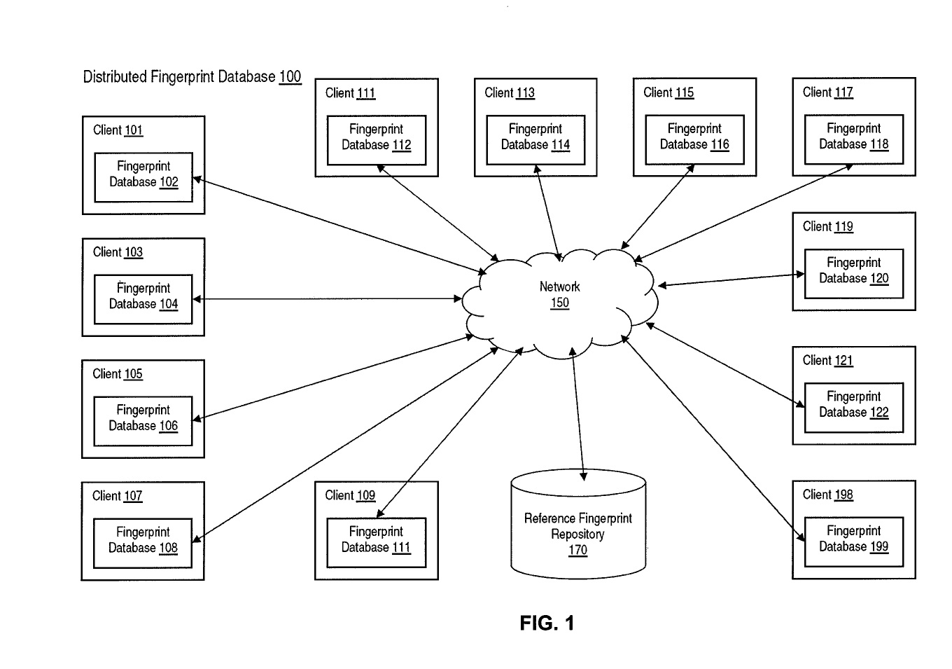

FIG. 1 depicts an example distributed media fingerprint database 100, according to an embodiment of the present invention. Example media fingerprint database 100 is distributed over multiple (e.g., two or more) client devices of a data network 150. A media fingerprint database according to an embodiment may be distributed over fewer or more clients than those depicted in FIG. 1, which is intended to be descriptively illustrative, yet by no means limiting. Network 150 may include one or more networks, which may include a local area network (LAN), a wide area network (WAN), the interne, network area storage (NAS), a storage area network (SAN), a CDS related network, and/or a P2P network.

Client devices 101, 103, 105, 107, 109, 111, 113, 115, 117, 119, 121 and 198 may be computing devices such as servers, which are communicatively coupled with data network 150. The client devices may include an edge server of network 1010, a server associated with a CDS, or a client of a P2P network. An information container instance of the distributed fingerprint database is disposed with each of the clients. Client 101 has a distributed fingerprint database information container instance (labeled in FIG. 1 as “fingerprint database”) 102.

Client 103 has a distributed fingerprint database information container instance 104. Client 105 has a distributed fingerprint database information container instance 106. Client 107 has a distributed fingerprint database information container instance 108. Client 109 has a distributed fingerprint database information container instance 110. Client 111 has a distributed fingerprint database information container instance 112. Client 113 has a distributed fingerprint database information container instance 114. Client 115 has a distributed fingerprint database information container instance 116. Client 117 has a distributed fingerprint database information container instance 118. Client 119 has a distributed fingerprint database information container instance 120. Client 121 has a distributed fingerprint database information container instance 122. Client 198 has a distributed fingerprint database information container instance 199.

Media fingerprints may be stored among the distributed fingerprint database information container instances according to a criterion that relates individually to each of the media fingerprints. Upon a query directed to one of the media fingerprints, at least one of the two or more computing devices is selected based on the criterion. The query is executed over the distributed database instance of the selected computing device. The criterion may relate to, for example, a quality of timeliness, a value, or statistical information, which are associated with the media fingerprint or the media content from which it is derived and to which it uniquely corresponds. The selection may also be performed based on a characteristic of computing device (e.g., client computer). For example, the client characteristic upon which the selection may also be based may include a network or physical location of the client, a computational attribute or a networking attribute of the client at query time, statistical information that relates to the client, latency associated with the client, or the availability of the client over data network 150 at query time, or a condition of data network 1010 at query time, etc.

A reference media fingerprint repository 170 may mirror instances of media fingerprints stored at the client devices or push instances of the media fingerprints thereto for storage. Reference media fingerprint repository 170 may be a client of data network 150.

### Example Media Fingerprint System

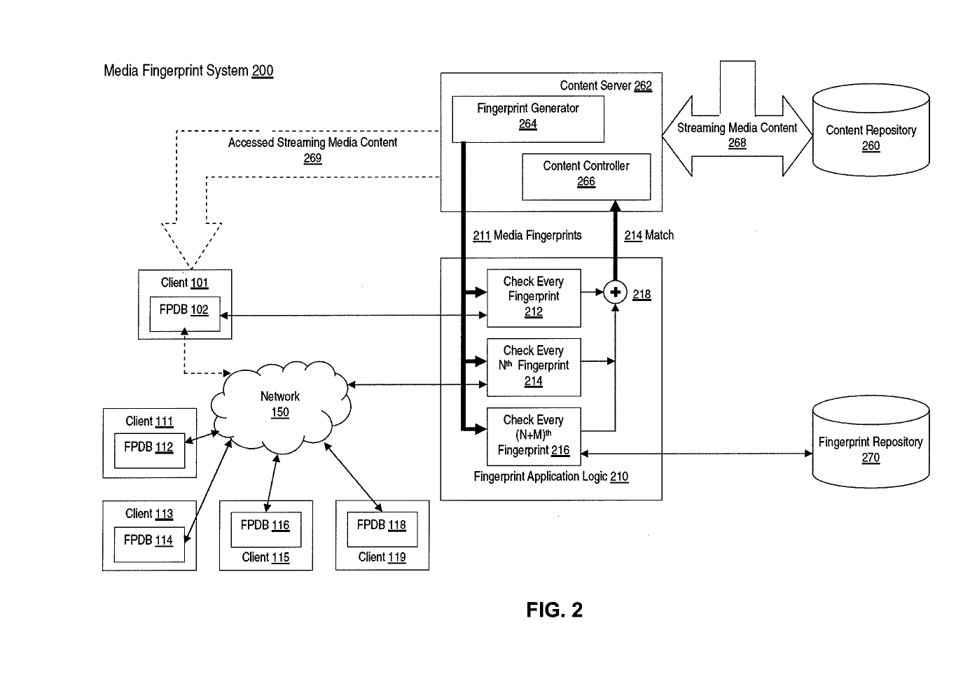

FIG. 2 depicts an example media fingerprint system 200, according to an embodiment of the present invention. Media fingerprint system 200 has a media content repository 260 and a media content server 262. Media fingerprint system 200 may function with distributed media fingerprint database 100 (FIG. 1). For example, media content server 262 may function to provide (e.g., serve, stream) streaming media content 268 to clients of data network 150. Streaming media content 268 may be stored in media content repository 260 and/or accessed therefrom. Upon a request from client 101 for access to particular media content (e.g., streaming media content 268), media content server 262 may allow access thereto and thus streams accessed media content 269 to client 101.

Media content server 262 has a media fingerprint generator 264 and a content controller 266. Media content server 262 functions with media fingerprint application logic 210. As accessed media content 269 streams, fingerprint generator 264 derives (e.g., computes or extracts, from components of the media content such as values relating to luma, chroma, or motion related values of video content) media fingerprints therefrom. Content server 262 provides the media fingerprints derived from streaming media content 268 or 269 to fingerprint application logic 210. A function of content server 262 or fingerprint application logic 210 may be performed with, disposed over, or distributed over one or more clients of network 150 (e.g., clients 101, 111, 113, 1115, 119, etc.).

Fingerprint application logic 210 has fingerprint checkers 212, 214 and 216. Fingerprint application logic 210 may have fewer or more fingerprint checkers than those depicted in FIG. 2, which is intended to be descriptively illustrative, yet by no means limiting. Fingerprint checker 212 queries media fingerprint database information container instance (labeled “FPDB” in FIG. 2) 102 in relation to every (or nearly every) fingerprint 211, which is derived from streaming content 268 or 269.

According to fingerprint logic 210, fingerprint checker 214 selects one or more of clients 111, 113, 115 or 119 (or e.g., another client of network 150, as shown in FIG. 1) and queries one or more of the media fingerprint database information container instance 112, 114, 116 or 118 respectively disposed each therewith in relation to every Nth media fingerprint 211, which is derived from streaming content 268 or 269, in which N is a whole number value greater than two. The value of N may relate to a cardinal count of consecutive media fingerprints successively derived from streaming content 268 or 269 or a time value associated with the derivation of the media fingerprints in relation to the duration of the streaming of the content.

According to fingerprint logic 210, fingerprint checker 216 selects and queries fingerprint repository 270 in relation to every (N+M)th media fingerprint 211, which is derived from streaming content 268 or 269, in which N is a whole number value greater than two and M, a whole number value greater than one. The value of (N+M) may thus relate to a cardinal count of consecutive media fingerprints successively derived from streaming content 268 or 269 or a time value associated with the derivation of the media fingerprints in relation to the duration of the streaming of the content, which is at least greater than the value of N. Media fingerprint repository may relate to a reference repository (e.g., reference repository 170; FIG. 1). Media fingerprint repository may also or alternatively relate to one or more of the media fingerprint database information container instances disposed over clients of data network 150.

Fingerprint application logic 210 has an adder function 218. Fingerprint checkers 212, 214 and 216 each provide returns of the queries, performed over media fingerprint database information container instances 102, one or more of media fingerprint database information container instances 112, 114, 116, 119, etc., and repository 270 to adder 218. Upon each query return provided to adder 218 indicating that each of the derived fingerprints 211 match a fingerprint stored in media fingerprint database information container instances 102, one or more of media fingerprint database information container instances 112, 114, 116, 119, etc., and repository 270, adder 218 provides a match indication (e.g., signal) to content controller 266.

Content controller 266 controls access to streaming media content 268. For example, upon receiving a match indication 214, content controller 266 allows client 101 to access media content stream 269. However, where no match 214 is provided to content controller 266, content controller 266 may deter access to streaming media content 269 by client 101. In an embodiment, a function of content controller 266 may be performed by a device, system or the like that causes presentation (e.g., display) of an advertisement or other associated information, such as with a pop-up (or e.g., drop-down) window or the like.

For example, media fingerprint database information container instances 102 may not store one or more media fingerprints that match the fingerprints 211, which are derived from media content 268 or 269 and thus returns a negative result to a query from fingerprint checker 212, while one or more of media fingerprint database information container instances 112, 114, 116, 119, etc., and/or repository 270 may return a positive result to corresponding queries from fingerprint checkers 214 and 216, respectively. This may indicate or imply that client 101 lacks authorization to access an instance of media content stream 268. Thus, while content controller 266 may allow access by other clients of data network 150 to streaming content 269, the content controller may also function to block, prevent, interrupt, distort, delay, replace, impede, or interfere with access to the streaming content by client 101.

Other action content controller 266 may take in relation to allowing client 101 access to streaming content 269 may include providing information, which may be associated with the media content instance (such as auxiliary, advertising, educational, instructional, commercial or other information that relates in some way to the media content), e.g., in real time or at least near real time in relation to the streaming of the media content instance. Content controller 266 may further function, to provide a mechanism to allow access thereto, which may have been deterred, to begin, resume, or continue with the deterrence abated or removed. For example, a web page, electronic form or the like may be provided to a user of client 101, which may include an offer to access streaming media content instance 269 without deterrence upon remunerating a fee or providing some other form of consideration.

### Example Procedures

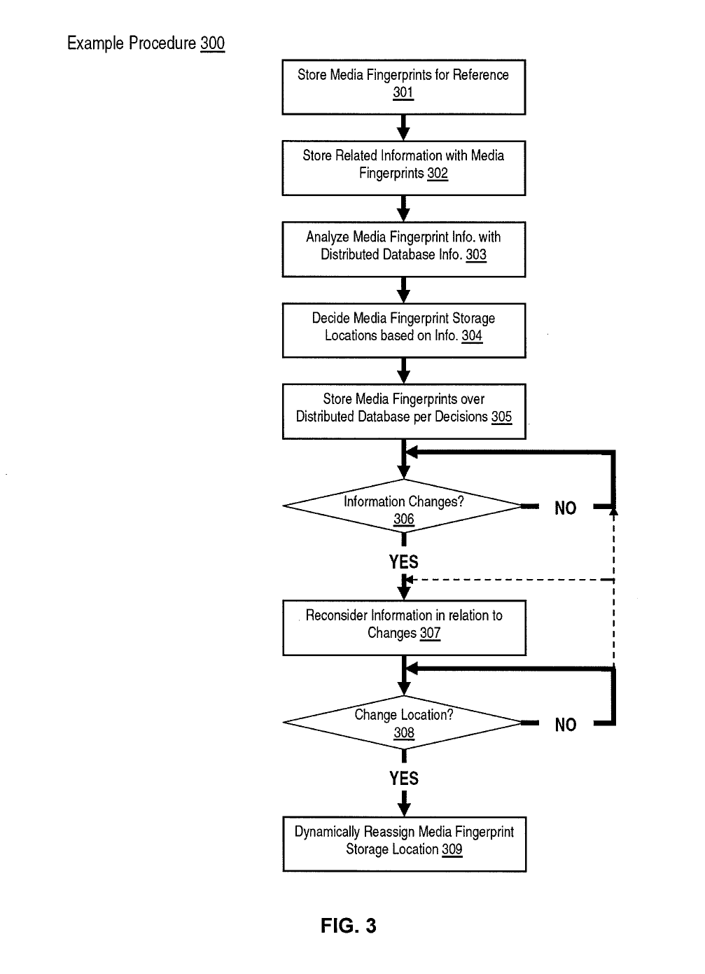

FIG. 3 depicts a flowchart for an example procedure 300, according to an embodiment. In step 301, media fingerprints that have been derived from media content are stored for reference. In step 302, information, such as metadata that relate to the reference media fingerprints, is stored therewith. The information may relate to storage time associated with a fingerprint, age of media content from which a fingerprint is derived, economic or other value relating to a fingerprint or content from which it is derived, geographic or other location related information associated with a fingerprint or its associated media content and the like.

In step 303, the information is analyzed, along with network, computational, latency, location related, economic or other information that relates to a distributed database over which the fingerprints are to be stored. Based on the analysis of the fingerprint related information and distributed database related information, decisions are made in step 304 that relate to storage locations to be assigned for each media fingerprint over which of multiple media fingerprint database information container instances. In step 305, media fingerprints are stored in one or more of the information container instances and the distributed database is thus configured based on the decisions.

In step 306, it is determined whether the fingerprint and distributed database related information has changed. If not, then step 306 may be repeated periodically or in response to indication of such a change. If information has changed, then in step 307 the information is reconsidered in relation to the changes thereto. In step 308, it is determined whether the information changes warrant reconsidering the storage decisions. If not, then steps 306, 307 and/or 308 may be repeated periodically or in response to indication that reconsidering the storage decisions becomes warranted. If the information changes warrant reconsidering the storage decisions, then in step 309 one or more of the storage locations are dynamically reassigned based on the reconsideration.

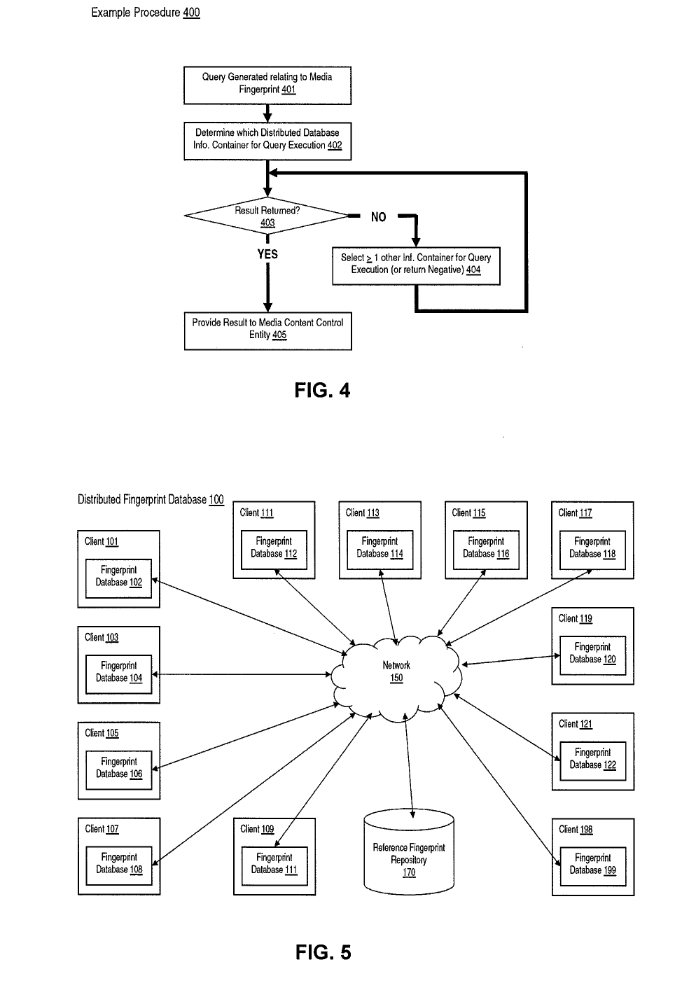

FIG. 4 depicts a flowchart for an example procedure 400, according to an embodiment. In step 401, a query is generated in relation to one or more media fingerprints that are derived from an instance of streaming media content. In step 402, it is determined which one or more of multiple information container instances of a distributed database of media fingerprints over which to compute the query.

In step 403, it is determined whether a result is returned from those of the one or more of multiple information container instances over which the query is computed. If no (or a negative) result is returned, then in step 404 one or more multiple information container instances of the distributed fingerprint database that were not initially queried are selected over which to compute the query. Upon a match (e.g., a positive result) from the query, in step 405 the result is provided to an entity, which the entity may use to control access to the content or provide information associated with the media content. If no positive result is returned after executing a query over the entire distributed fingerprint database, then a negative result may be returned with step 404.

### Example Applications

Embodiments may thus relate to design or architecture for distributed databases and other information repositories for storing multimedia fingerprints. Media fingerprinting systems may use a unique, dedicated, specifically tasked, or task-sharing repository for storing media fingerprints. For example, a unique database may store some, all, virtually all, or a substantial component of all media fingerprints that have been derived from media content, e.g., from portions of certain pieces or instances of content, such as portions of a video sequence, music or the like. Media fingerprints may then be used to uniquely identify the media content portion from which they are derived.

For example, a media fingerprint derived from a content portion may be compared to media fingerprints stored in the fingerprint database. Finding a match allows the content portion to be identified. Moreover, a match allows auxiliary information, which is indexed to the fingerprint derived therefrom, to be associated with the content. In this context, a portion of media content portion may thus function as a query over a fingerprint database.

The identity of the media content portion, and the associated information, may thus be considered to comprise a result of computing the query over the fingerprint repository. In essence, streaming or uploading portions of media content function as a query against records stored within the containers of the fingerprint database. Embodiments may function with media fingerprints stored over a distributed information repository such as a distributed database system.

Fingerprints derived from media content may be distributed among several databases, e.g., in a distributed database system. The multiple fingerprint databases may be physically or logically proximate or remote. For instance, collocated or be at different locations and be connected be any kind of telephony or data network. The distributed database system may function with clustered computing features. The distributed information repositories may be physically or logically disposed over multiple databases. The distributed repositories may be networked, mirrored, clustered and/or redundant. Distributed repositories used herein may include SAN or NAS components.

Requests may be received more frequently for access to some media content for access to others. For example, some movies may be more popular than others. Thus, requests may be received more frequently to stream or download more popular movies than may be received for less popular movies. Requests to access media content may be legitimate. For example, a requester may have rights as a purchaser or subscriber to stream or to download particular media content. Similarly, an authorized content publisher may, for example legitimately upload their own or licensed content. Media fingerprints derived from the content uniquely identifies the content and may be used to index information associated therewith, as described herein.

Not all requests for access to content are legitimate however. So-called media or content “piracy” sometimes refers to unauthorized, perhaps illegal streaming or downloading of copyrighted content without consent of the copyright holder or uploading content from a user not licensed to do so. Unfortunately, the more popularity a particular media content piece enjoys, the more likely it may be for illegitimate access requests to be received and for illegitimate streaming, downloading or uploading of instances thereof to occur. Media fingerprints may be used to detect unauthorized or other illegitimate streaming, downloading, uploading or other theft of content or in fact, to uniquely identify even such stolen instances thereof after the fact (e.g., upon replay).

Embodiments function to determine the likelihood that various media content will be requested for access, e.g., by an enterprise or other entity associated with storing content and/or media fingerprints derived therefrom. The determined likelihood that access to a particular piece of media content may be requested may then be used to assign, proactively or reactively, a storage location within a distributed information repository for media fingerprints derived from that content. An embodiment may also use the determined likelihood of receiving access requests to particular content or, any changes thereto, to dynamically assign or re-assign (e.g., change) the storage location within a distributed information repository for media fingerprints derived from that content, e.g., from one storage location to another within the distributed repository. Thus, as the determined likelihood that access may be requested to particular pieces of content media may change over time (or as certain events or conditions develop), embodiments allow dynamic reassignment of storage locations within the distributed fingerprint repository of media fingerprints corresponding to that content. Embodiments may thus promote access speed and efficiency and economize on computing or networking resources consumed in executing queries over the fingerprint repository.

In an embodiment, an enterprise or other entity associated with a content repository maintains statistics associated with requests received for access to media content stored therewith. In an embodiment, an enterprise or other entity associated with the distributed fingerprint repository maintains statistics associated with queries submitted for all fingerprints stored therewith. The entities may be related, co-functional or the same. The entities may exchange usage information for content and fingerprints and thus, the entity associated with the distributed fingerprint repository may maintain statistics associated with queries submitted for all fingerprints stored therewith, as well as for content access requests received.

The entity operating the repository may thus realize that certain content is more likely to be requested than other content. Fingerprints related to the more likely requested content may thus be inferred to be accessed more frequently, as well. An embodiment structures fingerprint databases and other repositories on the basis of content, classified according to its likelihood to be requested for access.

An embodiment functions within a networking environment. Repositories for fingerprints of different classes may be co-located or disposed with different network entities. An embodiment may function within a peer-to-peer (P2P) networking environment. In a P2P network, repositories for each of the different class fingerprints may be associated with different clients (e.g., client-peers).

In an embodiment, fingerprint repositories may be duplicated or mirrored some multiple of times. A multiplication factor may relate to the class standing, e.g., the “importance” associated with a given repository. For example, a first class fingerprint repository may be duplicated with a multiplication factor that is greater than that with which the second class repository is duplicated and, the Nth class fingerprint repository may not be duplicated at all or, if it is, it may be duplicated at a multiplication factor that is lower than that of any of the “higher” classes. The multiplication factor may be a whole number (e.g., greater than zero).

The length of time that a media fingerprint remains in a given repository may be pre-defined. In an embodiment, a length of time that a fingerprint corresponding to certain multimedia file remains in a repository of a given class may also be based on usage statistics associated with the fingerprint or with the media content from which it is derived.

Fingerprint storage locations may also be dynamically distributed among repositories of different classes. A fingerprint storage location may be downgraded or upgraded. For example, a fingerprint stored in a first class repository may be shifted to the second or a lower class repository in the event that it is not returned in response to a query during a given time span or over a certain number of queries. Similarly, a fingerprint stored in an Nth class repository may be shifted to the second or a higher class repository. Such gradation (classification) changes may be based on changing (e.g., rising or falling) usage statistics associated with a given fingerprint or the media content from which a fingerprint is derived. Fingerprint files may be distributed among repositories of different classes according to a pre-defined scheme.

Further, the assignment of repository classes to certain servers or to P2P client-peers may be pre-defined, dynamically flexible, or randomized. An embodiment uses a statistical approach to decide on how many P2P client-peers may store repositories of a certain class. The statistical approach may be of benefit where for example, not all client-peers are active at all times in a P2P network.

Embodiments may thus relate to a system of distributed, prioritized information repositories, which enhances scalability for media fingerprint storage. Prioritized repositories may be searched sequentially.

Applications may also be supported in which fingerprint repositories are not necessarily prioritized or searched sequentially. In an embodiment, a fingerprint repository is split into several “branch” or “child” repositories. Queries may execute over the split repositories in parallel, e.g., using parallel processing. Further, the parallel running search processes may exchange information, e.g., in real time with respect to computing the queries in parallel, which may increase the accuracy and/or reduce latency associated with the search. For example, a search process may initiate exclusion of certain fingerprints from an executing query based on a metric unique or related to the nature of a particular query. The search process that excludes the certain fingerprints may transfer information relating to the exclusion to the other search processes running in parallel therewith, which may increase the accuracy and/or reduce latency associated with running the parallel searches.

### DEFINITIONS, NOMENCLATURE & REFERENCES

### “Media Fingerprints”

Media fingerprints are unique identifiers of media content from which they are derived, e.g., computed, extracted, generated, etc. The term “fingerprint” is aptly used to refer to the uniqueness of these media content identifiers, in the sense that human beings are uniquely identifiable, e.g., forensically, by their fingerprints. While similar to a signature, media fingerprints perhaps even more intimately and identifiably correspond to the content. Audio and video media may both be identified using media fingerprints that correspond to each medium.

Audio media are identifiable with acoustic fingerprints. An acoustic fingerprint is generated from a particular audio waveform as code that uniquely corresponds thereto. Upon generating an acoustic fingerprint, the corresponding waveform from which the fingerprint was generated may thereafter be identified by reference to its fingerprint. The acoustic fingerprints may be stored, e.g., in a database. Stored acoustic fingerprints may be accessed to identify, categorize or otherwise classify an audio sample to which it is compared. Acoustic fingerprints are thus useful in identifying music or other recorded, streamed or otherwise transmitted audio media being played by a user, managing sound libraries, monitoring broadcasts, network activities and advertising, and identifying video content (such as a movie) from audio content (such as a soundtrack) associated therewith.

The reliability of an acoustic fingerprint relates to the specificity with which it identifiably corresponds with a particular audio waveform. Some audio fingerprints provide identification so accurately that they may be relied upon to identify separate performances of the same music. Moreover, some acoustic fingerprints are based on audio content as it is perceived by the human psychoacoustic system. Such robust audio fingerprints thus allow audio content to be identified after compression, decompression, transcoding and other changes to the content made with perceptually based audio codecs; even codecs that involve lossy compression (and which may thus tend to degrade audio content quality). Analogous to identifying audio media content by comparison with acoustic fingerprints is the ability to identify video media with digital video fingerprints.

Video fingerprints are generated from the video content to which they correspond. A sequence of video information, e.g., a video stream or clip, is accessed and analyzed. Components characteristic of the video sequence are identified and extracted therefrom. Characteristic components may include luminance, chrominance, motion descriptors and/or other features that may be perceived by the human psychovisual system. The extracted components are compressed into a readily storable and retrievable format.

Video fingerprints may be generated using relatively lossy compression techniques, which render the fingerprint data small in comparison to their corresponding video content. Reconstructing original video content from their corresponding video fingerprints is thus typically neither practical nor feasible. As used herein, a video fingerprint thus refers to a relatively low bit rate representation of an original video content file. Storing and accessing the video fingerprints however is thus more efficient and economical

Stored video fingerprints may be accessed for comparison to a sample of a video sequence, which allows accurate identification of the video content in the sequence. Video fingerprints are thus useful for accurately identifying video content for a user as the content is viewed, as well as in authoritatively managing copyrights, and in validating authorized, and detecting unauthorized, versions and instances of content being stored, streamed or otherwise used. As with many acoustic fingerprints moreover, video fingerprints are perceptually encoded. Thus the content of the video sequence may be accurately identified by comparison to video fingerprints after compression, decompression, transcoding and other changes to the content made with perceptually based video codecs; even codecs that involve lossy compression (and which may thus tend to degrade video content quality).

Audio and video media content may be conceptually, commercially or otherwise related in some way to separate and distinct instances of content. The content that is related to the audio and video content which may include, but is not limited to other audio, video or multimedia content. For instance, a certain song may relate to a particular movie in some conceptual way. Other example may be text files or a computer graphics that relate to a given speech, lecture or musical piece in some commercial context. However, it may not be easy to ascertain the existence of some content that may be related to particular media content, much less to access the related content in association with the media content.

A media fingerprint is derived (e.g., computed, extracted) from a portion of media content. Information is associated with the media content portion based on the extracted media fingerprint. Upon linking to the associated information, the associated information content is presented with the media content portion. As used herein, the terms “associated information,” “associated information content,” and “associated content” may be essentially used synonymously, and the terms “auxiliary information,” “auxiliary associated information,” and “auxiliary content” may refer essentially to the associated information.

As used herein, the term “medium” (plural: “media”) may refer to a storage or transfer container for data and other information. As used herein, the term “multimedia” may refer to media which contain information in multiple forms. Multimedia information files may, for instance, contain audio, video, image, graphical, text, animated and/or other information, and various combinations thereof. As used herein, the term “associated information” may refer to information that relates in some way to information media content. Associated information may comprise, for instance, auxiliary content.

As used herein, the term “media fingerprint” may refer to a representation of a media content file, which is extracted from characteristic components thereof. Media fingerprints are derived (e.g., extracted, generated, etc.) from the media content to which they correspond. As used herein, the term “acoustic fingerprint” may refer to a media fingerprint that may be associated with audio media with some degree of particularity (although an acoustic fingerprint may also be associated with other media, as well). As used herein, the term “video fingerprint” may refer to a media fingerprint associated with video media with some degree of particularity (although a video fingerprint may also be associated with other media, as well). Media fingerprints used in embodiments herein may correspond to audio, video, image, graphical, text, animated and/or other media information content, and/or to various combinations thereof, and may refer to other media in addition to media to which they may be associated with some degree of particularity.

Media fingerprints, as described herein, may conform essentially to media fingerprints as described in co-pending Provisional U.S. patent application No. 60/969,543 filed on Aug. 31, 2007, by Philip Bernosky, Claus Bauer, Jack Buser and Guido Voltolina, entitled “Associating Information with a Portion of Media Content,” and assigned to the assignee of the present invention (with Patent Docket No. D07022), incorporated by reference for all purposes as if fully set forth herein.

Media fingerprints, as described herein, may conform essentially to media fingerprints as described in co-pending Provisional U.S. patent application No. 61/026,446 filed on Feb. 5, 2008, by Philip Bernosky, Claus Bauer, Jack Buser and Guido Voltolina, entitled “Associating Information with a Portion of Media Content,” and assigned to the assignee of the present invention (with Patent Docket No. D07022US02), incorporated by reference for all purposes as if fully set forth herein.

Media fingerprints, as described herein, may conform essentially to media fingerprints as described in co-pending Provisional U.S. patent application No. 60/997,943 filed on Oct. 5, 2007, by Ragunathan Radhakhrishnan and Claus Bauer, entitled “Media Fingerprints that Reliably Correspond to Media Content” and assigned to the assignee of the present invention (with Patent Docket No. D07037), incorporated by reference for all purposes as if fully set forth herein.

Media fingerprints, as described herein, may conform essentially to media fingerprints as described in co-pending Provisional U.S. patent application No. 60/930,905 filed on May 17, 2007, by Ragunathan Radhakhrishnan and Claus Bauer, entitled “Video Fingerprint Comparison Resilient to Frame Rate Conversion” and assigned to the assignee of the present invention (with Patent Docket No. DOL214), incorporated by reference for all purposes as if fully set forth herein.

An acoustic fingerprint, for example, may comprise unique code that is generated from an audio waveform, which comprises the audio media content, using a digital signal processing technique. Also for example, a video fingerprint may comprise a unique digital video file, the components of which are extracted and compressed from characteristic components of video content. Extracted characteristic components of video content that may be compressed to form a video fingerprint corresponding thereto may include, but are not limited to, luminance values, chrominance values, motion estimation, prediction and compensation values, and the like. Thus, while media fingerprints described herein represent the media content from which they are derived, they do not comprise and (e.g., for the purposes and in the context of the description herein) are not to be confused with metadata that may be associated with the media content. Media fingerprints may be transmissible with lower bit rates than the media content from which they are derived. As used herein, the terms “computing,” “deriving,” “generating,” “writing,” “extracting,” “compressing” and the like may relate to obtaining media fingerprints from media content portions and may, in the context of media fingerprints, be used interchangeably (e.g., synonymously) herein. These and similar terms may thus relate to a relationship of media fingerprints to source media content thereof or associated therewith. Media fingerprints may thus function to uniquely and robustly represent, identify, reference or refer to the media content from which they are derived. Concomitantly, these and similar terms herein may be understood to emphasize that media fingerprints are distinct from meta data, tags and other descriptors, which may be added to content for labeling or descriptive purposes and, e.g., subsequently extracted therefrom. In contexts relating to derivative media content, the terms “derive” and “derivative” may further relate to media content that may represent or comprise other than an original instance of media content.

### “Associated Information” & “Linking” Therewith

As used herein, the terms “associated information,” “associated content,” “auxiliary content,” and “auxiliary information,” in relation to a multimedia or other media content file, may refer to information that is indexed by a certain part of the media content file. The auxiliary information itself may not necessarily be identical, or even approximate, to any part of the multimedia itself. For example, a certain portion of a particular video file may index the temperature in a certain location, e.g., New York City, at a certain day or time. The New York City temperature may thus comprise auxiliary content, related to that part of the video. In another example, a certain portion of a given video file may index a certain model and manufacturing year of a certain model of a particular car manufacturer.

Indexing may be done when an original media file, e.g., a whole movie, is created. However, an embodiment provides a mechanism that enables the linking of a segment of video to auxiliary content during its presentation, e.g., upon a movie playback. An embodiment functions where only parts of a multimedia file are played back, presented on different sets of devices, in different lengths and formats, and/or after various modifications of the video file. Modifications may include, but are not limited to, editing, scaling, transcoding, and creating derivative works thereof, e.g., insertion of the part into other media. Modifications may also include geometric changes or distortions such as rotations or pans, arbitrary or otherwise, with which content may be intentionally or unintentionally made somewhat distinct with respect to an original instance thereof. Another example of content modification may include content to which information such as digital watermarks may be added.

As used herein, the terms “link,” “linked,” “linking” and the like may refer to storing one or more pointers to auxiliary content in a repository such as a database or list of media fingerprints, storing one or more universal resource locators (URL) of one or more locations that contain auxiliary content in a repository such as a database or list of media fingerprints, storing one or more database references that contain auxiliary content in a repository such as a database or list of media fingerprints, or the like. As used herein, the term “links” may refer to retrieving auxiliary content from one or more pointers stored in a repository such as a database or list of media fingerprints, retrieving auxiliary content from one or more files referred to by a repository such as a database or list of media fingerprints retrieving auxiliary content using one or more URLs stored in a repository such as a database or list of media fingerprints, retrieving auxiliary content from one or more database references stored in a repository such as a database or list of media fingerprints, or the like.

An embodiment allows identification of auxiliary content that was assigned to a specific part of a media file when the whole media product was created, even when the file is played back in parts, sequences, and modified forms. Moreover, an embodiment functions without metadata and thus does not require the insertion generation or other operations with metadata related to the content or any modification of the content. Embodiments function with media of virtually any type, including video and audio files and multimedia playback of audio and video files and the like.

Information such as auxiliary content is associated with media content. In an embodiment, media fingerprints such as audio and video fingerprints are used for identifying media content portions. Media fingerprinting identifies not only the whole media work, but also the exact part of the media being presented, e.g., currently being played.

In an embodiment, an information repository, such as a database, of media fingerprints of media files is maintained. Another repository (e.g., database) maps specific media fingerprints, which represent specific portions of certain media content, to associated auxiliary content. The auxiliary content may be assigned to the specific media content portion when the media content is created. Upon the media content portion's presentation, a media fingerprint corresponding to the part being presented is compared to the media fingerprints in the mapping database. The comparison may be performed essentially in real time, with respect to presenting the media content portion.

For example, a part of a movie may be played on a video related webpage. A media fingerprint corresponding to the part being played is extracted therefrom essentially in real time. The media fingerprint is compared to the fingerprints in the mapping database. Upon identification, e.g., to which part of any movies in the mapping database the part being played back belongs, auxiliary content originally or otherwise assigned to this part of a movie is identified and linked to or retrieved.

An embodiment allows an advertiser to “purchase,” in a sense, a scene of a video. A vendor or an agent thereof (such as a search engine or a web services provider) may thus choose to associate an advertisement for a product, service or the like with a certain media content portion. For example, a soft drink company could identify a scene where an actor is drinking a specific product of their company. The soft drink company or its agent may purchase rights to use the media fingerprint corresponding to that scene to associate their advertisement with that particular media content portion. Thus, upon presenting that scene to a viewer, information associated with that media content portion is linked to and the soft drink company's advertisement is presented, essentially in real time with respect to the scene playing.

The advertising content may be presented next to, proximate to, or overlaid on the video scene. Whenever this specific part of the movie is presented on virtually any media presentation device connected to the Internet or another network facilitating the embodiment, the part of the movie is identified using the media fingerprint technology. Thus, the purchaser and the associated information play-back webpage are informed. Depending on an exchange agreement between the purchaser and the media content provider or other entity presenting the media content, a related advertisement, defined by the purchaser, is shown in real time with or after the corresponding media content portion is presented.

Moreover, an embodiment presents the auxiliary information or other associated information faithfully when the corresponding media content portion is presented, even if the corresponding media content portion is used in derivative content, such as a trailer, an advertisement, or even an unauthorized copy of the media content, pirated for example, for display on a social networking site. In whatever format the media content portion is presented, it is recognized and linked to information associated therewith, such as the auxiliary content. In an embodiment, a portion of media content is used in a search query.

### EXAMPLE IMPLEMENTATIONS AND PLATFORMS

### Example Information Repositories

Example embodiments may be implemented with a variety of information repositories, including databases, file systems and the like. Embodiments may be implemented for example with a database management system (DBMS). Embodiments of the present invention are not limited to any particular database or other repository architecture. The repository may store a body of records in one or more data containers. A data container may conform to tables in a relational database, a collection of objects (e.g., instances of object classes) in an object oriented database, or the like. The records within the body of records may conform to rows in a table, objects of an object class, or the like. The attributes of the records may conform to columns of the rows of a table, object attributes, or the like. For clarity, simplicity, unity, and brevity of description, example procedures may be described herein with reference to relational databases. It should be appreciated however that embodiments are well suited to execution with any kind of database architecture (e.g., object oriented) or other information repository.

Example embodiments may be implemented with information that may be stored in one or more co-functional databases, each of which may function with one or more computers. Example embodiments may be implemented with a sharing of computational tasks over the multiple computers. Each of the multiple computers may be linked, or communicatively coupled, with one or more of the others via one or more data or telecommunication networks. Example embodiments may be implemented with a distributed database system. One or more of multiple database servers may be physically proximate to, or remote from, one or more of the other database servers.

Example embodiments may be implemented with mirrored databases or other information repositories. Example embodiments may be implemented with databases that include a primary and a logical or physical standby database. One or more mirror or standby databases may be physically proximate to, or remote from, one or more of the other (e.g., primary) databases.

Information is conveniently stored in repositories such as databases. Stored information is accessed and updated with applications executing in a database management system (DBMS). A DBMS functions both to efficiently store information in one or more containers and as a database server to efficiently retrieve the information therefrom, on request. Moreover, a DBMS functions to ensure that data retrieved therewith is fresh information and thus, to concomitantly deter retrieval of stale information. Each of the data containers of a database contains records. The data within each record is organized into one or more attribute fields. Various database architectures exist.

The data containers of relational databases are tables and the records stored therein are rows. Relational databases may contain virtually any number of tables, the attributes of which, are referred to as columns. The data containers of an object oriented database are object classes, the records of which comprise objects, which have attributes referred to as object attributes. Other database architectures also exist. Databases in general and relational databases more particularly are described herein for simplicity and unity, solely by way of example and illustration, and not for any limiting purpose.

Information may be stored in one or more co-functional databases, each of which may function with one or more computers. Further, in processing large quantities of information, speed and/or efficiency may be promoted by sharing computational tasks over multiple computers. Each of the multiple computers is linked, or communicatively coupled, with one or more of the others via one or more networks. A database server that functions in such a networked, multi-computer, distributed computing environment, such as a computer cluster, may be referred to herein as a distributed database system. One or more of the multiple database servers may be physically proximate to, or remote from, one or more of the other database servers.

Databases and other information repositories may be mirrored. For example, a first instance of information content may be stored with a first database and a second instance of essentially the same content may be stored at a second database. The second instance of content may substantially duplicate the first instance thereof. The second repository thus mirrors the first repository. Moreover, one database may function to back up data that is stored in another database. For example, a third database ‘A’ may function as a standby database for a primary or production database ‘B’. The standby database ‘A’ may store a physical instance or a logical instance of information stored in the primary database ‘B’. One or more mirror or standby databases may be physically proximate to, or remote from, one or more of the other (e.g., primary) databases.

To retrieve data stored in a database, queries are submitted to a database server, which computes the query and returns the data requested therewith. Query statements submitted to a database server typically conform to syntax characteristic of a particular database language with which the DBMS functions. SQL (Structured Query Language) and PL/SQL (Procedural Language/SQL) are well known examples of such languages. Other database languages, some of them proprietary, may also be also used.

In an embodiment, a computer system performs one or more features described above. The computer system includes one or more processors and may function with hardware, software, firmware and/or any combination thereof to execute one or more of the features described above. The processor(s) and/or other components of the computer system may function, in executing one or more of the features described above, under the direction of computer-readable and executable instructions, which may be encoded in one or multiple computer-readable storage media and/or received by the computer system.

In an embodiment, one or more of the features described above execute in a decoder or a server, which may include hardware, software, firmware and/or any combination thereof, which functions on a computer platform. The computer platform may be disposed with or deployed as a component of an electronic device such as a TV, a DVD player, a gaming device, a workstation, desktop, laptop, hand-held or other computer, a network capable communication device such as a cellular telephone, portable digital assistant (PDA), a portable gaming device, or the like. One or more of the features described above may be implemented with an integrated circuit (IC) device, configured for executing the features. The IC may be an application specific IC (ASIC) and/or a programmable IC device such as a microcontroller, a programmable logic device (PLD), or a field programmable gate array (FPGA).

### Example Computer System Platform

FIG. 5 depicts an example computer system platform 500, with which an embodiment of the present invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), cathode ray tube (CRT) or the like, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Embodiments of the invention relate to the use of computer system 500 with distributed media fingerprint repositories. According to one embodiment of the invention, associating information with media content is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and other conductors and fiber optics, including the wires that comprise bus 502. Transmission media can also take the form of electromagnetic or acoustic waves, such as those generated during radio wave and infrared or other optical data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a digital subscriber line (DSL), cable or other modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for functionality with distributed media fingerprint repositories, as described herein.

The received code may be executed by processor 504 as it is received, and/or stored in storage device 510, or other non-volatile storage for later execution. In this manner, computer system 500 may obtain application code in the form of a carrier wave.

### ENUMERATED EXAMPLE EMBODIMENTS

Some embodiments of the present invention may thus relate to one or more of the examples that are enumerated below.

1. A method, comprising the steps of:
storing a plurality of media fingerprints, which are each derived from and uniquely correspond to a portion of media content, over a distributed database;
wherein an instance of one or more information containers of the distributed database are each disposed over two or more computing devices, which are communicatively coupled over a data network; and
wherein the storing step comprises the step of distributing each of the plurality of media fingerprints among the one or more information containers based on at least a first criterion that relates individually to each of the media fingerprints;
upon a query directed to one of the media fingerprints, selecting at least one of the two or more computing devices based on one or more of the first criterion or a second; and
executing the query over the distributed database instance of the selected at least one computing device.

2. The method as recited in Enumerated Example Embodiment 1 wherein the first criterion relates to one or more of a timeliness, a value, or statistical information, which are associated with one or more of the media content or the media fingerprint derived therefrom and uniquely corresponding thereto.

3. The method as recited in Enumerated Example Embodiment 1 wherein the selecting step is also performed based on the second criterion; and
wherein the second criterion relates to a characteristic of the at least one computing device.

4. The method as recited in Enumerated Example Embodiment 3 wherein the characteristic relates to one or more of:
one or more of a location of the computing device;
one or more of a computational attribute or a networking attribute of the computing device at query time;
one or more of statistical information relating to the computing device, a latency associated with the computing device, or an availability of the computing device over the data network at query time; or
a condition of the data network at query time.

5. The method as recited in Enumerated Example Embodiment 1 wherein at least one of the two or more computing devices comprises a server.

6. The method as recited in Enumerated Example Embodiment 1 wherein the data network comprises a peer to peer network.

7. The method as recited in Enumerated Example Embodiment 6 wherein at least one of the two or more computing devices comprises a client of the peer to peer network.

8. The method as recited in Enumerated Example Embodiment 1 wherein an instance of the media content streams over the data network; and
wherein the query relates to the media content instance.

9. The method as recited in Enumerated Example Embodiment 8, further comprising the steps of:
computing the query;
returning a result based on the computing step; and
acting in relation to the streaming of the media content instance based on the returned result of the query.

10. The method as recited in Enumerated Example Embodiment 9 wherein the acting step comprises the step of:
controlling the streaming of the media content instance.

11. The method as recited in Enumerated Example Embodiment 10 wherein the controlling step comprises one or more of the steps of:
deterring the streaming of the media content instance; or
providing information that is associated with the media content instance in at least near real time in relation to the streaming of the media content instance.

12. The method as recited in Enumerated Example Embodiment 11 wherein the media content instance streams to an entity that is communicatively coupled with the data network upon a request from the entity to access the media content; and
wherein the deterring step comprises the step of:
deterring the streaming of the media content instance to the entity; and
allowing the media content to stream over a portion of the data network apart from the entity.

13. The method as recited in Enumerated Example Embodiment 1, further comprising the step of:
managing the distributed database;
wherein the managing step comprises the step of redistributing one or more of the plurality of media fingerprints among the one or more distributed database information container instances based on the criterion; and
wherein one or more of the selecting step or the executing the query step is performed based on the redistributing step.

14. The method as recited in Enumerated Example Embodiment 13 wherein the redistributing step comprises the step of:
dynamically reassigning a storage location for at least one of the media fingerprints from one or more first distributed database information container instances to at least one distributed database information container instance of at least one computing device, which is apart from the first distributed database information container instances.

15. The method as recited in Enumerated Example Embodiment 1 wherein the redistributing step comprises deleting the one or more of the plurality of media fingerprints from the one or more information containers.

16. A system, comprising:
a computer readable storage medium comprising computer executable instructions; and
at least one processor which, upon executing the instructions, controls the system to perform one or more of the method steps as recited in any of Enumerated Example Embodiments 1-15.

17. A system, comprising:
means for performing one or more of the method steps as recited in any of Enumerated Example Embodiments 1-15.
18. A computer readable storage medium comprising encoded instructions which, when executing with one or more processors, controls performance of the method steps as recited in any of Enumerated Example Embodiments 1-15.

19. A computer readable storage medium comprising encoded instructions which, when executing with one or more processors, configures one or more of the systems as recited in any of Enumerated Example Embodiments 17-18.

### EQUIVALENTS, EXTENSIONS, ALTERNATIVES AND MISCELLANEOUS

Example embodiments relating to distributed media fingerprint repositories are thus described. In the foregoing specification, embodiments of the present invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for redistributing media fingerprints over a plurality of distributed fingerprint database information container instances of a distributed fingerprint database, the method comprising the steps of:
redistributing a plurality of media fingerprints, which are each derived from and uniquely correspond to a portion of media content, over the distributed fingerprint database upon a change of at least a first criterion that relates individually to each of the media fingerprints;
wherein a distributed fingerprint database information container instance of one or more distributed fingerprint database information containers of the distributed fingerprint database are each disposed over two or more computing devices, which are communicatively coupled over a data network; and
wherein the redistributing step comprises the steps of:
storing each of the plurality of media fingerprints among those distributed fingerprint database information container instances that are selected based on at least the first criterion;
deleting each of the plurality of media fingerprints from those distributed fingerprint database information container instances that are no longer selected based on at least the first criterion;
wherein the first criterion relates to one or more of a timeliness, a value, or statistical information, which are associated with one or more of the media content or the media fingerprint derived therefrom and uniquely corresponding thereto;
upon a query generated or submitted in relation to one of the media fingerprints, selecting at least one of the two or more computing devices based on one or more of at least the first criterion, or the first criterion and a second criterion; and
executing the query over the distributed fingerprint database information container instance of the selected at least one computing device.

2. The method as recited in claim 1 wherein the first criterion relates to one or more of a timeliness, a value, or statistical information, which are is associated with one or more of the media content or the media fingerprint derived therefrom and uniquely corresponding thereto.

3. The method as recited in claim 1 wherein the selecting step is also performed based on the second criterion;
wherein the second criterion relates to a characteristic of the at least one of the computing devices; and
wherein the characteristic relates to one or more of:
one or more of a location of the at least one computing device;
one or more of a computational attribute or a networking attribute of the at least one computing device at query time;
one or more of statistical information relating to, a latency associated with, or an availability of the computing device over the data network at query time; or
a condition of the data network at query time.

4. The method as recited in claim 1 wherein an instance of the media content streams over the data network;
wherein the query relates to the media content instance;
wherein the method further comprising the steps of:
computing the query;
returning a result based on the computing step; and
acting in relation to the streaming of the media content instance based on the returned result of the query.

5. The method as recited in claim 4 wherein the acting step comprises the step of:
controlling the streaming of the media content instance;
wherein the controlling step comprises one or more of the steps of:
deterring the streaming of the media content instance; or
providing information that is associated with the media content instance in at least near real time in relation to the streaming of the media content instance;
wherein the media content instance streams to an entity that is communicatively coupled with the data network upon a request from the entity to access the media content; and
wherein the deterring step comprises the step of:
deterring the streaming of the media content instance to the entity; and
allowing the media content instance to stream over a portion of the data network apart from the entity.

6. The method as recited in claim 2 wherein the statistical information relates to a likelihood that the media content will be requested for access
wherein the method further comprises the step of:
determining the likelihood that the media content will be requested for access; and
wherein the step of redistributing the media fingerprints comprises the step of dynamically changing a storage location of one or more of the media content or the media fingerprint based on the determined likelihood.

7. The method as recited in claim 2 wherein the statistical information relates to a usage statistics of the media fingerprint that will be requested for access; and
wherein each distributed fingerprint database information container instance assigned to a class represents the usage statistics of its stored media fingerprints;
wherein the method further comprises the step of:
determining the usage statistics of the media fingerprint that will be requested for access; and
wherein, upon the usage statistics rising, the step of dynamically changing a storage location of one or more of the media content or the media fingerprint based on the changing statistical information comprises moving the one or more of the media content or the media fingerprint to a distributed fingerprint database information container instance of a higher class; and
wherein, upon the usage statistics falling, the step of dynamically changing a storage location of one or more of the media content or the media fingerprint based on the changing statistical information comprises moving the one or more of the media content or the media fingerprint to a distributed fingerprint database information container instance of a lower class.

8. The method as recited in claim 1, prior to the redistributing step further comprising the step of:
distributing a plurality of media fingerprints, which are each derived from and uniquely correspond to a portion of media content, over the distributed fingerprint database;
wherein the distributing step comprises the step of:
storing each of the plurality of media fingerprints among the one or more distributed fingerprint database information container instances that are selected based on at least the first criterion.

9. The method as recited in claim 1 wherein the redistributing step comprises the step of:
dynamically reassigning a storage location for at least one of the media fingerprints from one or more first distributed fingerprint database information container instances to at least one distributed fingerprint database information container instance of at least one of the computing devices, which is apart from the first of the distributed fingerprint database information container instances.

10. A computer system that redistributes media fingerprints over a plurality of distributed fingerprint database information containers of a distributed fingerprint database, the computer system comprising:
a computer readable storage medium that comprises encoded computer executable instructions stored therewith; and
at least one processor which, upon executing the instructions, controls or programs the computer system to perform a process for redistributing media fingerprints over a plurality of distributed fingerprint database information container instances of a distributed fingerprint database, wherein the process comprises the steps of:
redistributing a plurality of media fingerprints, which are each derived from and uniquely correspond to a portion of media content, over the distributed fingerprint database upon a change of at least a first criterion that relates individually to each of the media fingerprints;
wherein a distributed fingerprint database information container instance of one or more distributed fingerprint database information containers of the distributed fingerprint database are each disposed over two or more computing devices, which are communicatively coupled over a data network; and
wherein the redistributing step comprises the steps of:
storing each of the plurality of media fingerprints among those distributed fingerprint database information container instances that are selected based on at least the first criterion;
deleting each of the plurality of media fingerprints from those distributed fingerprint database information container instances that are no longer selected based on at least the first criterion;
wherein the first criterion relates to one or more of a timeliness, a value, or statistical information, which are associated with one or more of the media content or the media fingerprint derived therefrom and uniquely corresponding thereto;
upon a query generated or submitted in relation to one of the media fingerprints, selecting at least one of the two or more computing devices based on one or more of at least the first criterion, or the first criterion and a second criterion; and
executing the query over the distributed fingerprint database information container instance of the selected at least one computing device.

11. A computer system for redistributing media fingerprints over a plurality of distributed fingerprint database information containers of distributed fingerprint database, comprising:
means for redistributing a plurality of media fingerprints, which are each derived from and uniquely correspond to a portion of media content, over the distributed fingerprint database upon a change of at least a first criterion that relates individually to each of the media fingerprints;
wherein a distributed fingerprint database information container instance of one or more distributed fingerprint database information containers of the distributed fingerprint database are each disposed over two or more computing devices, which are communicatively coupled over a data network; and
wherein the redistributing means comprises:
means for storing each of the plurality of media fingerprints among those distributed fingerprint database information container instances that are selected based on at least the first criterion;
means for deleting each of the plurality of media fingerprints from those distributed fingerprint database information container instances that are no longer selected based on at least the first criterion;
wherein the first criterion relates to one or more of a timeliness, a value, or statistical information, which are associated with one or more of the media content or the media fingerprint derived therefrom and uniquely corresponding thereto;
means for selecting, upon a query generated or submitted in relation to one of the media fingerprints, at least one of the two or more computing devices based on one or more of at least the first criterion, or the first criterion and a second criterion; and
means for executing the query over the distributed fingerprint database information container instance of the selected at least one computing device.

12. A computer readable storage medium that comprises encoded computer executable instructions, wherein the instructions are adapted for causing at least one processor to perform the steps of the method, wherein the method comprises:
redistributing a plurality of media fingerprints, which are each derived from and uniquely correspond to a portion of media content, over the distributed fingerprint database upon a change of at least a first criterion that relates individually to each of the media fingerprints;
wherein a distributed fingerprint database information container instance of one or more distributed fingerprint database information containers of the distributed fingerprint database are each disposed over two or more computing devices, which are communicatively coupled over a data network; and
wherein the redistributing step comprises the steps of:
storing each of the plurality of media fingerprints among those distributed fingerprint database information container instances that are selected based on at least the first criterion;
deleting each of the plurality of media fingerprints from those distributed fingerprint database information container instances that are no longer selected based on at least the first criterion;
wherein the first criterion relates to one or more of a timeliness, a value, or statistical information, which are associated with one or more of the media content or the media fingerprint derived therefrom and uniquely corresponding thereto;
upon a query generated or submitted in relation to one of the media fingerprints, selecting at least one of the two or more computing devices based on one or more of at least the first criterion, or the first criterion and a second criterion; and
executing the query over the distributed fingerprint database information container instance of the selected at least one computing device.
